(19) United States
(12) Patent Application Publication
(10) Pub. No.: US 2014/0114831 A1
(43) Pub. Date: Apr. 24, 2014

(54) System for Trading Electronic Traded Properties

(71) Applicant: Etre Financial, LLC, New York, NY (US)

(72) Inventors: Paul Frischer, Greenwich, CT (US); Jesse Stein, Brooklyn, NY (US); Scott Panzer, New Milford, CT (US); Jacob Frydman, Hyde Park, NY (US); Eli Verschleiser, Brooklyn, NY (US)

(73) Assignee: Etre Financial, LLC, New York, NY (US)

(21) Appl. No.: 14/028,629

(22) Filed: Sep. 17, 2013

Related U.S. Application Data
(60) Provisional application No. 61/715,921, filed on Oct. 19, 2012.

(51) Int. Cl. G06Q 40/04; G06Q 50/16

(52) U.S. Cl. CPC G06Q 40/04; G06Q 50/16
USPC 705/37

(57) ABSTRACT

A programmed computer for facilitating trades of electronic traded properties (ETP) including a memory and a processor executing program code stored in the memory. The program code includes code for receiving a number of shares and rentable building area for an ETP, code for generating an indifference factor for the ETP based on the number of shares and the rentable building area, code for receiving and displaying in real time a price expressed in price per share for the ETP, and code for generating and displaying in real time a price expressed in price per square foot based on the price expressed in price per share and the indifference factor.

This application claims priority to U.S. provisional patent application Ser. No. 61/715,921, filed Oct. 19, 2012, which is hereby incorporated by reference.

### BACKGROUND

Commercial real estate for the most part is an alternative investment. Although there has been limited success in the equity markets through the use of REITS and 1031 exchange platforms, the typical real estate transaction takes months to close, is extremely expensive, and usually offers limited investor options. Passive real estate investors are prone to be involuntary investors as the ability to dispose of direct limited partnership and direct real estate investments is constrained. Private opportunities also do not usually offer an investor nominal interest in the investment.

As a component of the commercial real estate market, in the equity investor environment, the relevance of price per share pricing, earnings per share, and other related share pricing conventions allow for like kind weighting, trading and rebalancing among equity investors to execute equity share pricing, perform fundamental and technical analysis, and develop related equity share price derivatives. In a manner similar to the like kind equity investor, the real estate market supports the buying and selling of commercial real estate by the real estate investor based on cap rate, price per square foot, rent roll and other distinct real estate attributes that allow for property pricing, trading, weighting and fundamental and technical analysis.

In other financial asset classes, like kind attribute pricing is used, such as dollar pricing in the case of commodities for a barrel of oil or the price of gold. In the cash markets, dollar pricing is used for interest rates, in the debt markets for bonds, and in alternative financial instruments. Examples of like kind investor trades include: 1) dollar pricing for one hundred dollars per barrel of oil, 2) sixteen hundred dollars per ounce of gold, 3) six hundred dollars per equity share of Apple stock and 4) linking stock options and warrants to equity share prices.

In the real estate market, the like kind format of pricing may be 1) the price per square foot of a building, 2) the equity share price of a building or 3) the portfolio square foot price or equity share price of a set of buildings.

In each like kind format, the share or denomination of pricing matches to a fungible value that each buyer and seller can relate to and price accordingly in order to execute like kind transactions. The overriding limitation in comparing a real estate investor to an equity investor, though, is they are disparate investors to each other. Equity investors typically consider price per share, and real estate investors typically consider price per square foot, and these disparate investors are faced with the challenge of determining value and pricing on the same asset or portfolio of assets and the ability to trade simultaneously at a moment of time and over time and duration of the asset. Without a method or system to manage the changing pricing paradigm between equity per share and price per square foot that disconnects pricing of commercial real estate for the disparate investor, the ability for equity share investors and real estate investors to trade simultaneously and over time and duration of the commercial real estate asset, remains the predominate disruptor of liquidity in the commercial real estate market.

### SUMMARY OF THE INVENTION

A programmed computer for facilitating trades of electronic traded properties (ETP) including a memory and a processor executing program code stored in the memory. The program code includes code for receiving a number of shares and rentable building area for an ETP, code for generating an indifference factor for the ETP based on the number of shares and the rentable building area, code for receiving and displaying in real time a price expressed in price per share for the ETP, and code for generating and displaying in real time a price expressed in price per square foot based on the price expressed in price per share and the indifference factor.

### DESCRIPTION OF THE DRAWINGS

The drawings presented herein are for the purposes of illustration, the invention is not limited to the precise arrangements and instrumentalities shown.

FIG. 1 represents a process/dataflow chart according to one aspect of the invention of the present disclosure.

FIG. 2 represents a flowchart according to one aspect of the invention of the present disclosure.

FIG. 3 represents a process/dataflow chart according to one aspect of the invention of the present disclosure.

FIG. 4 represents a computer system according to one aspect of the invention of the present disclosure.

FIGS. 5 and 6 represent Tables I-IV according to aspects of the invention of the present disclosure.

FIG. 7 represents a flowchart according to one aspect of the invention of the present disclosure.

FIG. 8 represents a screenshot of a trading screen according to one aspect of the invention of the present disclosure.

FIG. 9 represents a screenshot showing information used according to one aspect of the invention of the present disclosure.

### DESCRIPTION OF THE INVENTION

To overcome prior limitations, the present invention provides for a structure and conversion process that allows for commercial real estate assets to be priced in a fungible format for use by disparate investors, and to allow for the conversion of pricing that is not available in the current marketplace, through a process that relies on generating through a processor the indifference factor value formulation (IFVF) according to

IFVF=shares outstanding/building square feet;

EV Building/equity shares*IFVF=Price per foot;

EV Building/square feet/IFVF=Price per share;

so that the indifference factor value formulation may allow for simultaneous trading in price per equity share and price per square foot on the same asset or portfolio of assets simultaneously over time and duration based on the value of the asset.

The IFVF marketplace for real estate and equity investors may allow for disparate equity and real estate investors to buy and sell an asset simultaneously on dissimilar attributes, for the life and duration of the asset, and provide direct execution to buy and sell orders from these dissimilar attributes based on the value of the asset from price changes over time. With the IFVF, disparate investors may be able to realize the benefits of investing in real estate (cash flow, capital appreciation, leverage, inflation hedge), together with the benefits of investing in public equity securities (liquidity, accurate pricing, transparency).

In developing the IFVF structure through the use of a computer generated conversion process, the marketplace for disparate investors in commercial real estate may be greatly enhanced with improved liquidity, lower costs, and time to market. Both the equity share investor and the real estate investor can use an electronic screen interface and computer based digital platform that continuously updates prices that provide simultaneous pricing of an asset for both execution on price per share and price per foot, and can maintain indifference price execution based on the value of the asset at any moment of time.

The IFVF mechanism is critical for the disparate investor, since it allows for the real estate investor to price the market simultaneously in price per square foot and the equity investor to price in price per equity share, and allow both disparate investors to execute trades simultaneously. This is a critical consideration, as the disparate marketplace is not only dependent upon financial market considerations; the marketplace is exposed to non-financial events. In order for a disparate investor marketplace to be functional, at no time can the prices of one disparate investor be dislocated from the price of the other disparate investor, or the marketplace may breakdown.

With the use of the IFVF a disparate investor marketplace can be built to overcome the above limitations through the construction of an Electronic Traded Property (ETP). An ETP is a commercial real estate asset that uses the IFVF to establish both price per equity share and price per square foot to establish the security interest in a commercial real estate asset. As part of the ETP structure, the equity shares and the RBA of the commercial real estate asset may be used in the formation of the IFVF marketplace and for each ETP asset. RBA is based on the building size and may be, in one non-limiting example, the rentable building area measured in square feet and may be modified by building measurement techniques and other modifiers known to one of ordinary skill in the art.

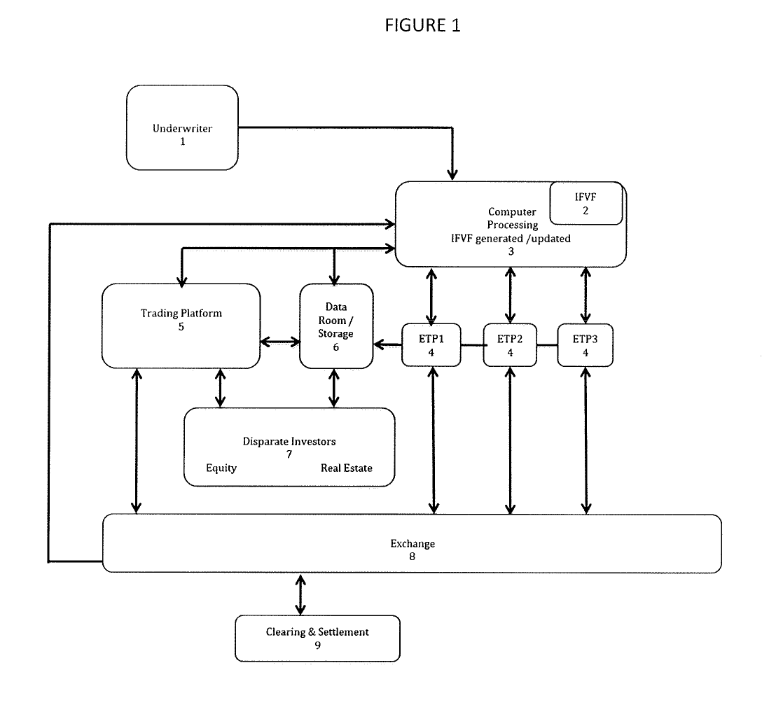

As shown in FIG. 1, each ETP 4 may be underwritten by the Underwriter 1, and the IFVF 2 may be processed by the Computer 3 to calculate the initial IFVF 2 for each individual ETP 4 and can be processed for a portfolio of ETP 4 assets (ETP1, ETP2, and ETP3). Each ETP 4 may be traded through the system and process described below as the IFVF 2 for each ETP 4 is being continuously updated based on financial and non-financial events in the marketplace.

The ETP 4 can be divided into shares that represent the equity, debt and enterprise value of the ETP 4 that are formed as a function of the RBA in square feet and the number of equity shares of the asset to allow for the computer processor to generate the changing IFVF 2 for each ETP 4. As the IFVF 2 may not remain constant over time and duration of the ETP, the system allows for simultaneous trading of price per equity share and price per square foot on the same asset and portfolio of assets simultaneously over time and duration based on the value of the ETP as the Computer processing 3 may continuously update the IFVF 2 based on financial and non-financial changes in the marketplace.

The IFVF marketplace may include a Trading Platform 5 that may deliver data dissemination, order matching, and order execution through a network of computers connected to Computer 3. The trading platform may allow Disparate Investors 7 to input buy and sell orders at specific prices per share and price per square foot converting simultaneously through the IFVF 2 to the individual ETP 4 or portfolio of ETPs 4 and for the securities that are being listed on a national exchange, OTC, or on a closed exchange platform 8. The platform 8 may consolidate these orders and display the orders to all disparate investors 7 in the form of a bid/ask order book on computer screens and through a network of computers. If a buy and sell order is placed, the trading platform 5 may process that as a trade. The trading platform 5 may be operated through proprietary software and computer hardware in a high-speed data center and at individual desktops. Investors may be able to create and fund accounts in order to make transactions that may work with clearing houses, brokerage firms, and settlement procedures.

The trading platform 5 may fully integrate order display, execution and trade reporting for all ETP 4 assets listed on the platform. All property information may be available to the general public including rent rolls, quarterly income statements, capital improvement budgets, third-party contracts, and loan/mortgage related documents through a data room 6. The trading platform 5 may contain features that include real time data dissemination of buy and sell orders, trading volume, and historical share prices and the information may be simultaneously used to maintain the IFVF 2 through time and duration and generate the indifference factor value for each disparate investor. Investors may be able to enter limit and stop orders. The platform 5 may provide disparate investors with a “screener” that may allow them to search for securities based on a number of criteria including but not limited to: location of the property, investment yield, property size, property type, leverage ratios, tenancy, and other financial metrics.

The platform 5 may provide basic technical and fundamental analysis tools to investors that may be inclusive of charts and financial calculations. When placing a bid or making an offer, the investor may see calculations such as property value and yield based on the price of their bid/offer and simultaneously see price per share and conversion to price per foot which can be traded simultaneously. Industry reports and analysis may be uploaded to the platform's site on a daily, monthly, and/or quarterly basis.

Shareholders may receive dividend payments from each ETP 4 in proportion to their ownership percentage. An outsourced Clearinghouse 9 may be responsible for settling trading accounts, clearing trades, collecting and maintaining margin monies, regulating delivery and reporting trading data.

In time, mortgage lenders in addition to equity and real estate disparate investors may prefer to finance an ETP for a variety of reasons as well. An ETP may be able to access additional equity capital more easily than private borrowers as the debt component of the enterprise value can be traded by disparate investors. Lenders may have access to real time information about their collateral and may be able to monitor their loans on a daily basis as a disparate investor. In addition to the real estate and equity investor, lender pools may be able to price assets indifferently based on value and may increase the pool of liquidity and the benefits associated with the IFVF platform.

Indifference Factor Value Formulation

The present invention provides an electronic marketplace for facilitating the underwriting, listing and trading of commercial real estate that brings together disparate buyers and sellers of equity shares and real estate investment. In the normal course of business, commercial real estate is generally purchased and sold either through direct building purchases based on the price per square foot or through an equity securitization process based on the value of the asset. Each of these methods is used by either the real estate investor or the equity investor and each method is disparate from the other.

IFVF improves on the limitations of like kind attribute buying and selling, to allow buyers and sellers of disparate trading practice (disparate investors of equity shares and direct real estate) to trade in the marketplace based on a computer generated conversion process that maintains a continuous indifference point of trading that allows for the conversion of price per share and price per square foot that can be priced to an equivalent mark to market value of an asset at any moment of time, and allow for trading prices to be maintained over time and duration at the indifference pricing point for each disparate investor to the value of an asset even though the factors of pricing for the asset may change over time.

An example of disparate investment pricing would be similar to the price of a barrel of oil and conversion directly to a share price of Exxon Mobil; or the price of an ounce of gold and conversion directly to a share price of BHP Billiton, or the price of an iPhone and conversion directly to a share price of Apple stock, and maintain over time and duration the indifference point of trading the price of an asset, even though the factors of pricing may change over time.

Under these conditions, IFVF overcomes the limitations exposed in the disparate investor marketplace with regard to the dislocation of prices between the disparate investor for a simultaneous transaction, and IFVF has the ability to maintain indifference pricing based on value over time and duration. These attributes of the IFVF may be shown in the examples below with the advent of share splits, building re-measurement, refinancing and other factors that are common to the impact on the value pricing changes of a commercial real estate asset, and with each pricing change over time requiring a means to create a comparative metric that would allow for disparate investors to be indifferent to pricing of the commercial real estate asset based on value. Although the method and system of IFVF may be used in other practices, the focus of this invention includes the conversion of equity share pricing and price per square foot pricing for commercial real estate investment among disparate investors.

### Example I

In the past, Building A at 300,000 square feet under a like kind format would allow for equity share pricing or per square foot pricing.

In the past, disparate investors (equity and real estate), could trade on the price per equity share or the price per square foot, but not both under like kind attribute pricing as events would occur in the marketplace to affect the pricing of the asset or portfolio of assets that would impact these dissimilar attributes with changes over time and duration and decouple the pricing of the asset by disparate investors.

A typical event that would decouple pricing may include a re-measurement of the RBA of Building A to 330,000 square feet. In the past, this event would have impaired like kind attribute pricing, since the impact would only affect one side of the pricing paradigm. Either the equity share price had to increase to offset the increase in the RBA measurement, or the price per square foot would have to decline to offset the increase in the RBA measurement to maintain the value of the asset, and in each case decouple the pricing paradigm.

To maintain the pricing paradigm for disparate investors, the IFVF structure would allow for a multi-sided pricing paradigm over the term and duration of the asset to be indifferent to price on the dissimilar attributes based on the value of the asset or on a group of assets.

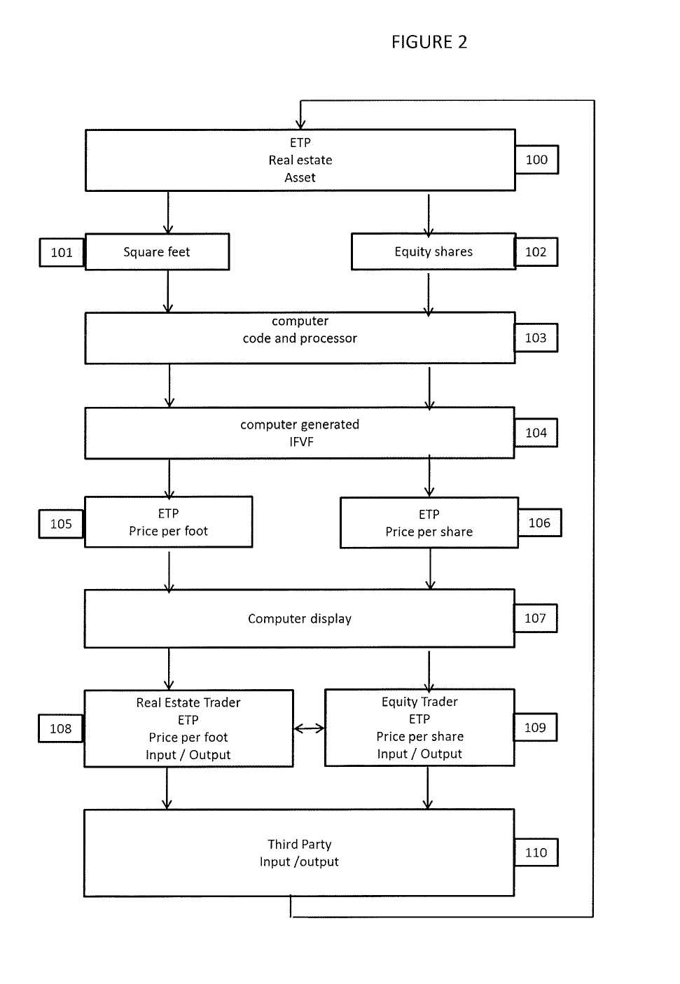

The above IFVF structure is shown in FIG. 2 based on ETP Real Estate Asset 100 with square feet 101 and equity shares 102. The multisided pricing paradigms are then managed through Computer 103 and IFVF 104 generated by the Computer 103 on a continuous basis, the value of the ETP price per square foot 105 and the ETP price per share 106 at each pricing event. The ETP price per square foot 105 and ETP price per share 106 can be displayed on a computer screen, and allow for simultaneous trading between Real Estate Trader 108 and Equity Trader 109 in both price per square foot and price per equity share, as the IFVF 104 through the Computer 103 to maintain the indifference pricing based on the value of Real Estate Asset 100 and the ETP price per square foot 105 and the ETP price per share 106 for the disparate investors Real estate trader 108 and Equity trader 109 based on Third Party input and output 110.

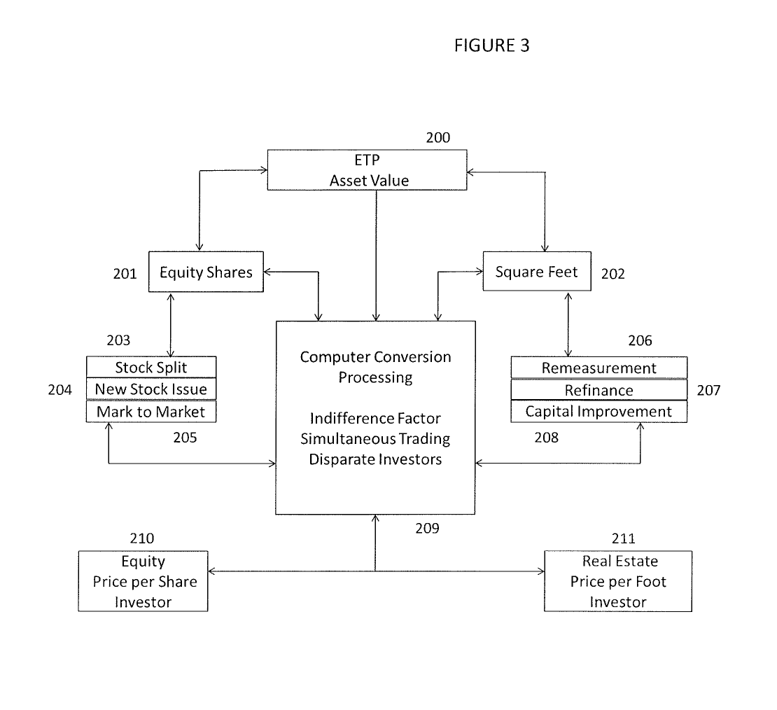

In FIG. 3, such instances of multi-sided pricing paradigms that may impact the value and pricing of ETP Asset Value 200 are events that are financial and non-financial that may alter the Equity Shares 201 and Square Feet 202. These events may include, Stock Split 203, New Stock Issue 204, Mark to Market 205, Re-measurement 206, Refinancing 207, Capital Improvement 208 and all other events that may require the computer conversion processing of the Indifference Factor 209, to maintain simultaneous trading for disparate investors Equity per Share Investor 210 and Real Estate Price per Foot investor 211 through these multi sided pricing paradigms.

In this manner the IFVF structure is not used as a like kind weighting, trading or rebalancing attribute to measure the value of a portfolio or a single asset. The indifference factor value allows for the conversion of pricing for disparate investors to look at the same asset and portfolio of assets with dissimilar pricing paradigms and have indifference pricing based on value that remains indifferent over time. In one aspect of the system of the present disclosure, the disparate investors are the equity investor and the real estate investor. In the examples below two buildings may be described in this manner as an ETP.

Indifference factor value formulation (IFVF)=Equity shares/Square feet

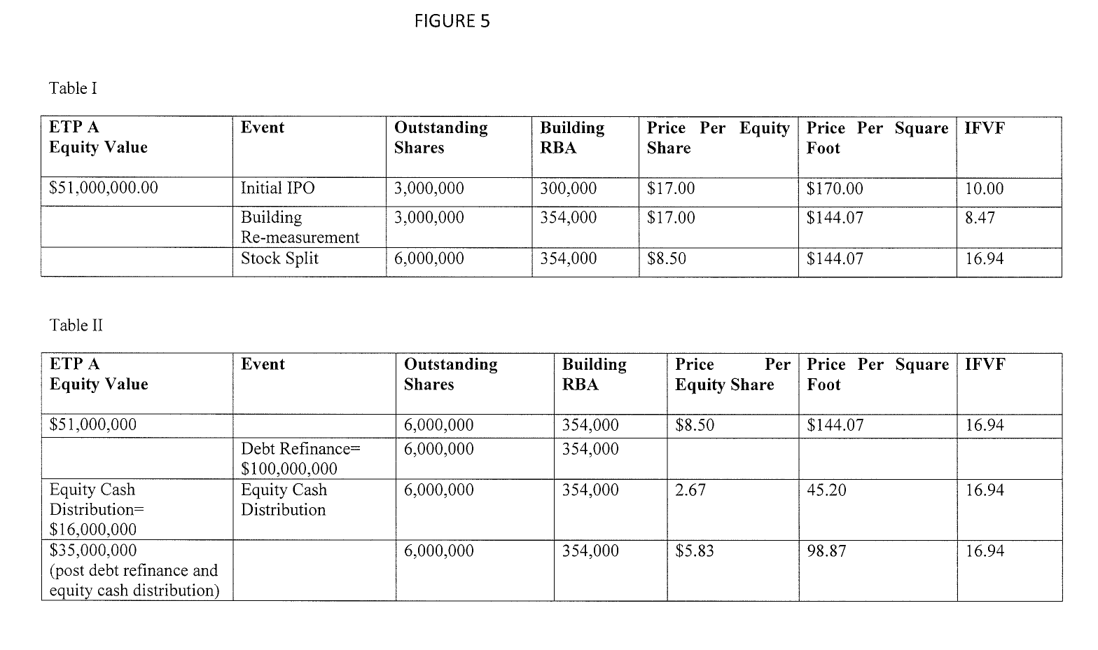

As shown in Table I of FIG. 5, with the IFVF approach, an initial IFVF can be used for each ETP to establish indifference pricing between the disparate investors and the building asset. In the example below the initial IFVF is calculated to be 10.

ETP A refers to building A with a RBA (rentable building area) of 300,000 square feet and has been allocated 3,000,000 million equity shares. Building A has $51,000,000 of equity value; $84,000,000 of debt value; and a total enterprise value of $135,000.000.00

Information Useful to the Equity Investor

Equity Market Cap per share=$17.00 ($51,000,000 equity/3,000,000 shares);

Debt per share=$28.00 ($84,000,000 debt/3,000,000 shares); and

Enterprise Value per share=$45.00 ($135,000,000/3,000,000 shares)

Information Useful to the Real Estate Investor

Equity Market Cap per square foot=$170.00 ($51,000,000 equity/300,000 square feet)

Debt per square foot=$280.00 ($84,000,000 debt/300,000 square feet)

Enterprise Value per square foot=$450.00 ($135,000,000/300,000 square feet)

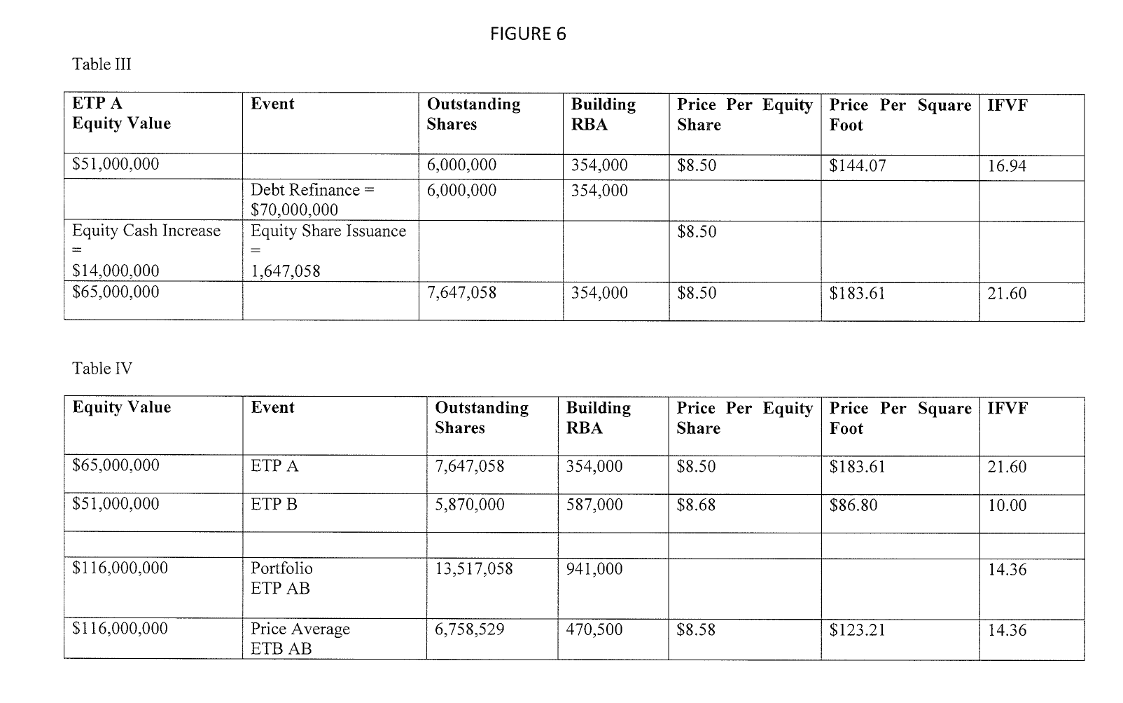

As shown in Table IV of FIG. 6, ETP B refers to building B with a RBA of 587,000 square feet and has been allocated 5,870,000 million equity shares, with $51,000,000 of equity value; $84,000,000 of debt value; and a total enterprise value of $135,000.000.00 the initial benefit of IFVF pricing becomes apparent.

Both ETP A and ETP B assets can be priced based on the IFVF accordingly:

Information Useful to the Equity Investor

Equity Market Cap per share=$8.68;

Debt per share=$14.30; and

Enterprise Value per share=$22.98

Information Useful to the Real Estate Investor

Equity Market Cap per square foot=$86.80;

Debt per square foot=$143.00; and

Enterprise Value per square foot=$229.80.

Under IFVF, the disparate investor may maintain an indifference price based on value over time, regardless of the changing financial and non-financial metrics of the marketplace. In the event the equity market cap increases, decreases or remains the same, or the enterprise value increases, decreases or remains the same, the per equity share pricing and the per square foot pricing reflect these aggregate price changes indifferently based on value between disparate investors. In the event the debt structure changes (increases and decreases in the mortgage or other debt instrument), the per square foot and per share pricing must reflect these changes indifferently based on value between disparate investors.

The method and system of the computer process that generates the indifference factor is critical when financial and non-financial pricing events occur, inclusive and not limited to the change in the number of shares through stock split or buyback, a change in the building RBA through re-measurement or alteration, and changes in mark-to-market pricing.

ETP A (Example I) is located in New York City and the RBA is regulated by the Real Estate Board of NY, and the loss factor (difference between rentable space and usable space) for all office buildings in NY are increased from 22% to 26%. This re-measurement would increase the RBA size of ETP A by 18%, although the physical size of the building never changed. The square feet allocated to ETP A that could be used for RBA increases from 300,000 to 354,000 as shown in Table I of FIG. 5.

With the computer processing of the IFVF reflecting a decrease from 10 to 8.4746, the equity share price and price per square foot price as a result of the building re-measurement do not have a dramatic impact on the disparate real estate investor, since the real estate investor has the IFVF to convert directly the per square foot price from the per share equity price.

In another situation with the IFVF computer processing, the disparate equity share investor can rely on the price per square foot pricing for equity share pricing in the event of a stock split. If a stock split occurred in ETP A as the next pricing paradigm after the RBA re-measurement with the additional issue of 3,000,000 equity shares, the price per share would change from the issuance of new shares, and the price per square foot would not change,

Under the IFVF platform, the computer processing generates an indifference factor to maintain continuous mark to market pricing and allows for direct conversion for the disparate equity and real estate investors to trade on ETP A at an indifference price on equity per share and price per square foot through each pricing paradigm, although only one side of the asset has been affected in each event.

Under the IFVF system and method of computer processing, the ability for two disparate investors to independently price the same asset and a portfolio of assets allows for greater liquidity in the marketplace, since the communication of information required for both the equity investor and the real estate investor has been maintained. The market changing price limitation in the past that would normally cause one investor to become dislocated from the other on the price indifference in the marketplace in a like kind investment environment is overcome through the IFVF, as the indifference pricing and the structure of trading allows for each disparate investor to price the same asset simultaneously over time and duration.

In effect, the increase in the RBA created the pricing situation that illustrates the benefit of the ETP and the IFVF structure, and overcomes the limitation for the disparate investor. For the equity investor, the price per share based on the change in the RBA would have no impact as the equity value remained the same, the number of shares remained the same, and the price per share remained at $17.00 price per share. In the past, if the real estate investor relied on the price per equity share price of $17.00, the impact would have been disastrous as the change in RBA had a direct impact on the price per square foot. With the IFVF conversion in place, the IFVF is calculated at 8.4745 and converted the price per square foot from $170.00 psf to $144.07 psf maintaining the indifference price point between the disparate investors.

The situation is the same for the equity investor in the event of the stock split under the IFVF, as the equity investor maintained the ability to make simultaneous trades as a disparate investor on the same ETP A as the real estate investor. Under the stock split, the share price decreased to $8.50 per equity share, as the price per square foot remained the same at $144.07 and the equity value of ETP A remained the same. In this situation, the IFVF increased to 16.94, and maintained the price per square foot at $144.07 for the real estate investor, as the price per equity share reduced to $8.50 based on the stock split.

Other decoupling events in the marketplace for disparate investors occur when the debt on a building is increased or decreased, as the impact has multiple pricing paradigms that must be reflected in the equity value, the debt component, and the enterprise value. In a debt restructuring and the procedures taken by the equity investor, the impact on the disparate investor has multiple outcomes on price per equity share and price per square foot. With the benefit of the IFVF, each ETP remains indifferent to these pricing paradigms as there is no dislocation on price for the disparate investor.

### Example II

Enterprise Value Property (EVP)=Equity Value (EV)−Debt (D)+Debt Refinance (DR)

DR>D; and EV with Cash Distribution

EV price per share decreases with cash distribution; EV price per foot decreases with cash distribution; and EVP remains the same.

As shown in Table II of FIG. 5 in the above example, the impact of the $100,000,000 debt refinance has no impact on the IFVF, although the price per share and the price per square foot both change as a result of the debt refinance and the cash distribution. It is important these factors are translated to the marketplace and to the disparate investor, as the amount of leverage (debt to equity ratio) used to finance the asset increases the risk to the investor. If the IFVF did not maintain the pricing relationship, the equity holder in the past would have had a decrease in the price per share value, and the real estate investor would not have been able to quantify the increase in the risk associated with the asset unless the decrease in price per square foot occurred based on the IFVF conversion.

### Example III

In the event that the debt refinance was not sufficient to meet the refinancing needs of the building, an additional cash infusion may be required from the equity, which can be done through the issuance of additional equity shares to the marketplace

Enterprise Value Property (EVP)=Equity Value (EV)−Debt (D)+Debt Refinance (DR).

DR<D; and EV with cash infusion.

In Example III, the EV price per share remains the same although there is an additional stock issuance (increase number of outstanding shares), the EV price per foot increases with the EV cash infusion, and the EVP remains the same.

As shown in Table III of FIG. 6, the dynamic relationship in Example III of the IFVF conversion with debt illustrates the impact of multiple pricing paradigms in maintaining the ability for disparate investors to buy and sell assets with price indifference based on value over the term of the asset under different pricing events. In this situation, the issuance of stock did not dilute the current share price as shown in Example I, and the cash proceeds were used to offset the current debt structure. As a result, the IFVF increased to 21.60 to reflect the increase in the price per square foot to the real estate investor, although the equity price per share for the equity share investor remained the same.

### Example IV

As shown in Table IV of FIG. 6, in a portfolio situation, the benefit of the IFVF becomes essential as the complexity of multiple buildings and the ability to trade simultaneously on price per share and price per square foot in the marketplace. In Example IV, ETP A and ETP B are combined as a portfolio, to illustrate the IFVF process.

Post the IPO of ETP A and numerous price paradigms that have impacted ETP A shown above in Examples I, II, III, the equity share price has decreased from $17.00 to $8.50, the price per square foot has increased from $170.00 to $183.61, and the IFVF has changed to 21.60. The equity value of ETP A has increased from $51,000,000 to $65,000,000. In comparison, ETP B values have remained constant.

In the past, the real estate investor would have become dislocated from the equity investor in pricing the portfolio of ETP A and ETP B based on the numerous pricing paradigms.

In the IFVF portfolio scenario, the equity investor and the real estate investor are not dislocated, as the IFVF process allows for both gross and average pricing of the assets. The equity share price and per square foot price remain indifferent based on value under the IFVF for the entire portfolio is 14.36, the average price per share is $8.58, and the price per square foot is $123.21. The IFVF processing for portfolio assets, allows for disparate investors (equity and real estate) to be indifferent on price, and can trade simultaneous and over time and duration on an entire portfolio, as the marketplace does not breakdown maintaining liquidity, lower cost, and time to market pricing.

In each of the examples above, the use of the IFVF and ETP structure shows the benefit for maintaining the ability of disparate investors to trade simultaneously on commercial real estate assets on disparate attributes. In each Example I, II, III, and IV below the IFVF structure may have shown the ability to overcome the limitations of the marketplace in the like kind trading manner, under which disparate investor in the past were subject to significant price dislocation which had proven to be ineffective in allowing disparate investors to trade on the same asset simultaneously over time and duration. The ability, then, to improve on the liquidity in the marketplace under the IFVF and ETP structure, provides investors with lower costs and property owners improved time to market, allows for commercial real estate assets to be traded in a format that has not been done before, and to allow disparate investors to trade simultaneously on the same asset over time and duration based on value.

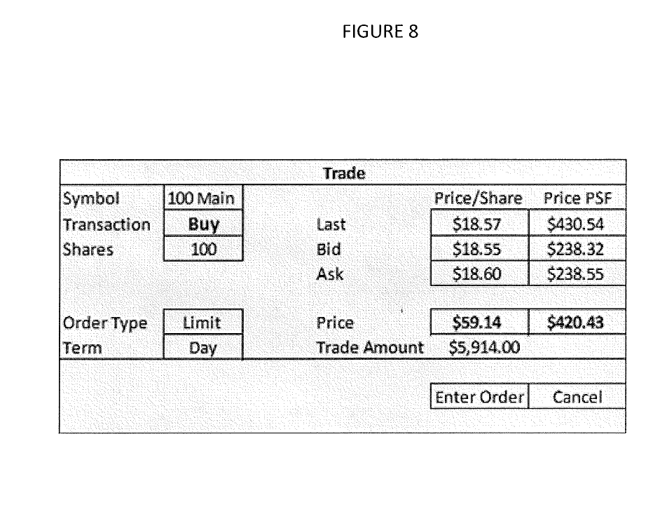

FIG. 8 represents a screenshot of a trading screen. In one aspect, for a property (100 Main St. indicated by symbol “100M”), a trader may indicate the type of transaction requested (“buy”), the number of shares for purchase (250), the order type (Limit), and term (Good Till Canceled) optionally with either the offered price per share or price per square foot. When the trader inputs the offered price in price per square foot, the system may automatically calculate and display the offered price in price per share for display to the user using the indifference factor. Conversely, when the trader inputs the offered price in price per equity share, the system may automatically calculate and display the offered price in price per square foot for display to the user using the indifference factor. The system may calculate and display the total cost of the order. The system may display “Last”, “Bid”, and “Ask” prices for the property in price/share and price per square foot.

Hotel Keys

In another aspect of the system of the present disclosure, as part of the ETP structure, the equity shares and the number of hotel rooms referred to as “keys” of the commercial real estate asset may be used in the formation of the IFVF marketplace and for each ETP asset. The key is based on the number of hotel rooms and may be, in one non-limiting example, the number of hotel rooms measured in keys and may be modified by building measurement techniques and other modifiers known to one of ordinary skill in the art.

As part of the ETP structure, the equity shares and the number of apartments in a multi-housing units referred to as “units” of the commercial real estate asset may be used in the formation of the IFVF marketplace and for each ETP asset. The unit is based on the number of apartments and may be, in one non-limiting example; the number of apartments measured in units and may be modified by building measurement techniques and other modifiers known to one of ordinary skill in the art.

Hotel Example I

Hotel A, which has three-hundred (300) rooms, with each room referred to as a “key”, under a like kind format would allow for either equity share pricing or price per key pricing. In the past, disparate investors (equity and real estate), could trade on the price per equity share or the price per key, but not both under like kind attribute pricing as events would occur in the marketplace to affect the pricing of the asset or portfolio of assets that would impact these dissimilar attributes with changes over time and duration, and decouple the pricing of the asset by disparate investors.

A typical event that would decouple pricing may include increasing the number of keys for Hotel A through a building reconfiguration to three-hundred thirty (330) keys. In the past, this event would have impaired like kind attribute pricing, since the impact would only affect one side of the pricing paradigm. Either the equity share price had to increase to offset the increase in the number of keys, or the price per key would have to decline to offset the increase in the number of keys to maintain the value of the asset, and in each case decouple the pricing paradigm.

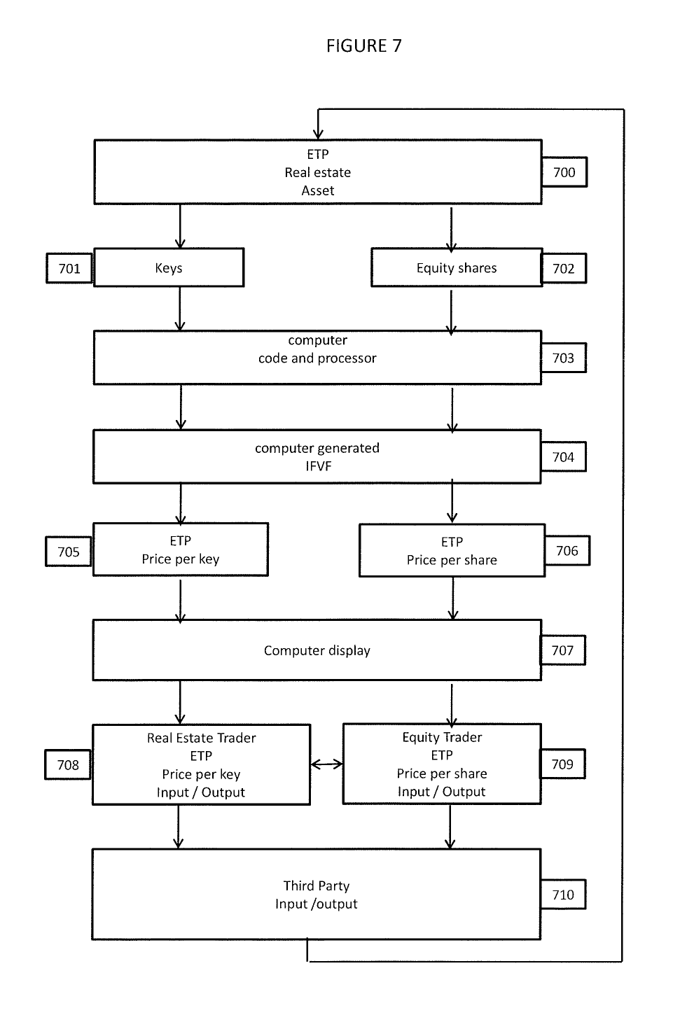

The above Hotel IFVF structure is shown in FIG. 7 based on ETP Real Estate Asset 700 with keys 701 and equity shares 702. The multisided pricing paradigms are then managed through Computer 703 and IFVF 704 generated by the Computer 703 on a continuous basis, the value of the ETP price per key 705 and the ETP price per share 706 at each pricing event. The ETP price per key 705 and ETP price per share 706 can be displayed on a computer screen, and allow for simultaneous trading between Real Estate Trader 708 and Equity Trader 709 in both price per key and price per equity share, as the IFVF 704 through the Computer 703 to maintain the indifference pricing based on the value of Real Estate Asset 700 and the ETP price per key 705 and the ETP price per share 706 for the disparate investors Real estate trader 708 and Equity trader 709 based on Third Party input and output 710.

As described above in connection with FIG. 3, such instances of multi-sided pricing paradigms that may impact the value and pricing of ETP Asset Value 200 may apply in the Hotel Example. In the Hotel Example, Number of Keys replaces Square Feet 202 as financial and non-financial events that may alter the Real Estate Price per Key Investor which replaces Real Estate Price per Foot Investor 211.

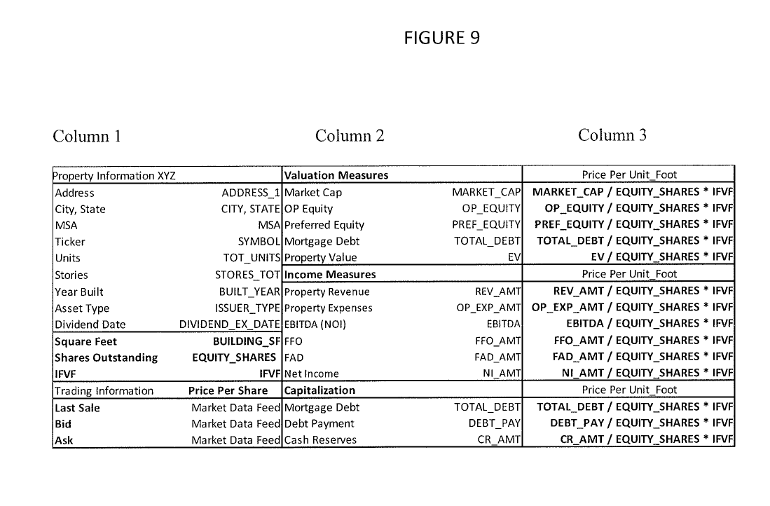

FIG. 9 represents a screen display showing a portion of the information contained in Data Room/Storage 6 shown in FIG. 1 that may be displayed on Computer Display 107 shown in FIG. 2. In one aspect, Columns 1 and 2 of FIG. 9 each show text on the left-hand-side and name or value of a corresponding variable on the right-hand-side. The variable may be updated in real time, inter-day, or end of day. By example, the Trading Information section shown in Column 1 may rely on prices for “last sale”, “bid”, and “ask supplied by a real time or delayed market data feed that are delivered and displayed in real time, and Income Measures shown in Column 2 may rely on values that are directed through sources of information with an end of day value. When the variables on the right hand side of Columns 1 and 2 are processed based on the IFVF, numerical expressions may be calculated and may yield a number for display to the user in Column 3. The expressions in Column 3 show the calculation of Price Per Unit Foot based on variables in Columns 1 and 2.

Computing Hardware

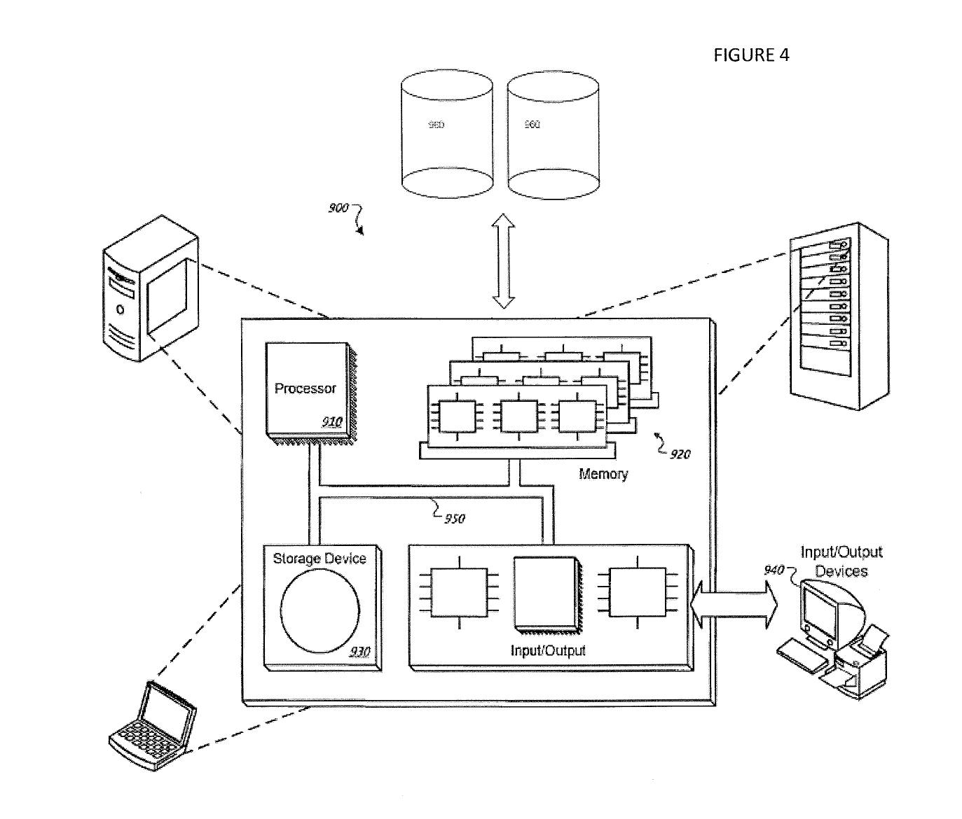

FIG. 4 shows a general purpose computer on which the system and method of the present disclosure may be implemented. The computer system 900 may execute at least some of the operations described above. Computer system 900 may include processor 910, memory 920, storage device 930, and input/output devices 940. Some or all of the components 910, 920, 930, and 940 may be interconnected via system bus 950. Processor 910 may be single or multi-threaded and may have one or more cores. Processor 910 may execute instructions, such as those stored in memory 920 or in storage device 930. Information may be received and output using one or more input/output devices 940.

Memory 920 may store information and may be a computer-readable medium, such as volatile or non volatile memory. Storage device 930 may provide storage for system 900 and may be a computer-readable medium. In various aspects, storage device 930 may be a flash memory device, a floppy disk device, a hard disk device, an optical disk device, or a tape device.

Input/output devices 940 may provide input/output operations for system 900. Input/output devices 940 may include a keyboard, pointing device, and microphone. Input/output devices 940 may further include a display unit for displaying graphical user interfaces, speaker, and printer. External data, such as financial data, may be stored in accessible external databases 960.

The features described may be implemented in digital electronic circuitry, or in computer hardware, firmware, software, or in combinations thereof. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output.

The described features may be implemented in one or more computer programs that are executable on a programmable system including at least one programmable processor coupled to receive data and instructions from, and to transmit data and instructions to, a data storage system, at least one input device, and at least one output device. A computer program may include set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors of any kind of computer. Generally, a processor may receive instructions and data from a read only memory or a random access memory or both. Such a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable, disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks may include, e.g., a LAN, a WAN, and the computers and networks forming the Internet.

The computer system may include clients and servers. A client and server may be remote from each other and interact through a network, such as the described one. The relationship of client and server may arise by virtue of computer programs running on the respective computers and having a client-server relationship to each other.

Numerous additional modifications and variations of the present disclosure are possible in view of the above teachings. It is therefore to be understood that within the scope of the appended claims, the present disclosure may be practiced other than as specifically described herein.

1. A programmed computer for facilitating trades of electronic traded properties (ETP), comprising:
a memory having at least one region for storing computer executable program code; and
a processor executing the program code stored in the memory, wherein the program code comprises:
code for receiving a number of shares and rentable building area for an ETP;
code for generating an indifference factor for the ETP based on the number of shares and the rentable building area;
code for receiving and displaying in real time a price expressed in price per share for the ETP;
code for generating and displaying in real time a price expressed in price per square foot based on the price expressed in price per share and the indifference factor;
code for generating and displaying in real time a market equity value expressed in price per share based on the price expressed in price per share and the number of shares;
code for generating and displaying in real time a market equity value expressed in price per square foot based the market equity value expressed in price per share and the indifference factor;
code for receiving and displaying in real time a first set of data for the ETP, the first set of data expressed in price per share and including one or more of mortgage debt, property value, and annual debt service; and
code for generating and displaying in real time a second set of data for the ETP based on the first set of data and the indifference factor, the second set of data expressed in price per square foot and including one or more of market equity value, mortgage debt, total property value, and annual debt service.

2. The programmed computer of claim 1, further comprising:
code for receiving updated information including at least one of number of shares and rentable building area and updating the indifference factor.

3. The programmed computer of claim 2, wherein events that trigger receipt of updated information include one or more of stock split, new stock issue, mark to market, re-measurement, refinancing, and capital improvement for an ETP.

4. The programmed computer of claim 1, further comprising:
code for receiving an order expressed in price per square foot;
code for generating a corresponding order expressed in price per share based on the order expressed in price per square foot and the indifference factor value;
code for transmitting the order expressed in price per share;
code for executing the trade in price per share;
code for receiving a confirmation of the executed trade in price per share based on the executed trade in price per square foot and the indifference factor, and
code for displaying a confirmation of the executed trade in price per square foot based on the executed trade in price per share and the indifference factor.

5. The programmed computer of claim 1, wherein the rentable building area is measured in square feet or meters.

6. A non-transitory tangible computer-readable medium having computer executable software code stored thereon, the code for facilitating trades of electronic traded properties (ETP), the code comprising:
code for receiving a number of shares and rentable building area for an ETP;
code for generating an indifference factor for the ETP based on the number of shares and the rentable building area;
code for receiving and displaying in real time a price expressed in price per share for the ETP;
code for generating and displaying in real time a price expressed in price per square foot based on the price expressed in price per share and the indifference factor;
code for generating and displaying in real time a market equity value expressed in price per share based on the price expressed in price per share and the number of shares;
code for generating and displaying in real time a market equity value expressed in price per square foot based the market equity value expressed in price per share and the indifference factor;
code for receiving and displaying in real time a first set of data for the ETP, the first set of data expressed in price per share and including one or more of mortgage debt, property value, and annual debt service; and
code for generating and displaying in real time a second set of data for the ETP based on the first set of data and the indifference factor, the second set of data expressed in price per square foot and including one or more of market equity value, mortgage debt, total property value, and annual debt service.

7. The non-transitory tangible computer-readable medium of claim 6, further comprising:
code for receiving updated information including at least one of number of shares and rentable building area and updating the indifference factor.

8. The non-transitory tangible computer-readable medium of claim 7, wherein events that trigger receipt of updated information include one or more of stock split, new stock issue, mark to market, re-measurement, refinancing, and capital improvement for an ETP.

9. The non-transitory tangible computer-readable medium of claim 6, further comprising:
code for receiving an order expressed in price per square foot;
code for generating a corresponding order expressed in price per share based on the order expressed in price per square foot and the indifference factor value;
code for transmitting the order expressed in price per share;
code for executing the trade in price per share;
code for receiving a confirmation of the executed trade in price per share based on the executed trade in price per square foot and the indifference factor, and
code for displaying a confirmation of the executed trade in price per square foot based on the executed trade in price per share and the indifference factor.

10. The non-transitory tangible computer-readable medium of claim 6, wherein the rentable building area is measured in square feet or meters.

11. A programmed computer for facilitating trades of electronic traded properties (ETP), comprising:
a memory having at least one region for storing computer executable program code; and
a processor executing the program code stored in the memory, wherein the program code comprises:
code for receiving a number of shares and number of units for an ETP;
code for generating an indifference factor for the ETP based on the number of shares and the number of units;
code for receiving and displaying in real time a price expressed in price per share for the ETP;
code for generating and displaying in real time a price expressed in price per unit based on the price expressed in price per share and the indifference factor;
code for generating and displaying in real time a market equity value expressed in price per share based on the price expressed in price per share and the number of shares;
code for generating and displaying in real time a market equity value expressed in price per unit based the market equity value expressed in price per share and the indifference factor;
code for receiving and displaying in real time a first set of data for the ETP, the first set of data expressed in price per share and including one or more of mortgage debt, property value, and annual debt service; and
code for generating and displaying in real time a second set of data for the ETP based on the first set of data and the indifference factor, the second set of data expressed in price per unit and including one or more of market equity value, mortgage debt, total property value, and annual debt service.

12. The programmed computer of claim 11, further comprising:
code for receiving updated information including at least one of number of shares and number of units and updating the indifference factor.

13. The programmed computer of claim 12, wherein events that trigger receipt of updated information include one or more of stock split, new stock issue, mark to market, re-positioning, refinancing, and capital improvement for an ETP.

14. The programmed computer of claim 11, further comprising:
code for receiving an order expressed in price per unit;
code for generating a corresponding order expressed in price per share based on the order expressed in price per unit and the indifference factor value;
code for transmitting the order expressed in price per share;
code for executing the trade in price per share;
code for receiving a confirmation of the executed trade in price per share based on the executed trade in price per unit and the indifference factor, and
code for displaying a confirmation of the executed trade in price per unit based on the executed trade in price per share and the indifference factor.
